(19) United States
(12) Patent Application Publication
(10) Pub. No.: US 2024/0262616 A1
(43) Pub. Date: Aug. 8, 2024

(54) Gas Inlet Assembly for Oil Tanks

(71) Applicant: GBA Marine AS, Kolbjörnsvik (NO)

(72) Inventors: Rune Bö, Arendal (NO); Helge K. Aasen, Kolbjörnsvik (NO)

(21) Appl. No.: 18/567,948

(22) PCT Filed: Jun. 17, 2022
(86) PCT No.: PCT/NO2022/050137

§ 371 Date: Dec. 7, 2023

(30) Foreign Application Priority Data
Jun. 18, 2021 (NO) 20210796

(51) Int. Cl. B65D 90/44

(52) U.S. Cl. CPC B65D 90/44

(57) ABSTRACT

A gas inlet assembly for oil tanks, connectable to a gas inlet pipe, for the maintenance of pressure and a non-explosive atmosphere during unloading of oil from an oil tank has at least one inlet conduit arranged to direct a unidirectional flow of gas from the inlet pipe to a primary inlet nozzle. The primary inlet nozzle includes a spreader element configured to spread the inflowing inert gas within the tank with a horizontal velocity component larger than the vertical velocity component.

### BACKGROUND

The disclosed embodiments relate to a method and/or system that allows addition of inert gas to the tanks of oil tankers during unloading in a manner that reduces the tendency of increased vaporization due to mechanically induced convection and turbulent mixing of tank atmosphere during unloading.

A challenge in handling of volatile fluids in large tanks, such as in oil tankers, is the vaporization of significant amounts of oil. On one hand, such vaporization is a loss of product and thereby an economic loss. Another aspect is that it causes pollution and a strain on the environment. Last, but not least, such evaporation is a safety risk and may cause fire or explosions.

Systems therefore have been designed to minimize or reverse such evaporation. One such system is described in WO 2007/086751, wherein vapour evaporated from oil is reintroduced into the oil. This and other systems are mainly designed for situations during transportation in which the tanks are closed and in a “steady state” condition, or for handling gas emissions during cargo loading operations.

A particular challenge occurs in situations in which the oil is unloaded from the tanks and the atmosphere over the continuously decreasing oil level is replaced by an inert gas introduced to maintain a certain pressure and to prevent explosion risks. The inventive embodiments disclosed herein minimize such problems during unloading of oil.

### SUMMARY

By “moderately conical” as used herein is understood a conical shape with an inclination of less than 25 degrees, more preferably less than 15 degrees and most preferred less than 5 degrees.

By “inversely conical” as used herein is understood a conical shape where the centre point is lower than the periphery.

By “negative vertical velocity component” as used herein is understood a vertical velocity component in upwards direction.

A specific aim of the disclosed embodiments is to increase the inlet area of the tank inlet opening since this leads to reduced velocity, reduced turbulence and thereby reduced vaporization. A simple extension of the inlet conduit would also lead to reduced velocity, but would still be subject to disturbances and turbulence in the incoming flow, and would be far from ideal in handling the overall challenge of reducing vaporization.

The disclosure offers a far better solution by directing the flow from the extended inlet conduit vertically down to a spreader disc that causes a 360 degrees spread of the inlet flow and ensuring that the dominant velocity component is horizontal from the spreader disc into the tank.

The spreader disc may be flat or moderately conical with a conical angle of a few degrees. It may also be “inversely” conical, i.e., with the centre of the spreader disc as its lowermost point. This latter embodiment is actually a preferred embodiment, causing the flow outwards from the spreader disc to be mainly horizontal with a small vertical velocity component that is actually upwards at the circumference of the spreader disc.

In yet another preferred embodiment the spreader disc is provided with a number of small holes to allow a small “leakage” flow to pass through the disc in a downwards direction. The holes are mainly to ensure that liquid is not collected on the disc, and the holes are sufficiently small so as not to significantly influence the general concept of largely horizontal gas flow into the tank, but will also contribute to increase the overall inlet area.

### BRIEF DESCRIPTION OF THE DRAWINGS

Below, the invention is described in further detail in the form of non-limiting embodiments illustrated by drawings, where:

FIG. 1 is a schematic side sectional view of a tank in which an embodiment of the present invention is included,

FIGS. 2A-2C are top sectional views of three variants of the vertical inlet conduit.

FIGS. 3A-3D are schematic side sectional views of variants of an inlet gas supply nozzle,

FIG. 4 is a schematic side sectional view of another embodiment of the present invention the earlier embodiments.

### DETAILED DESCRIPTION

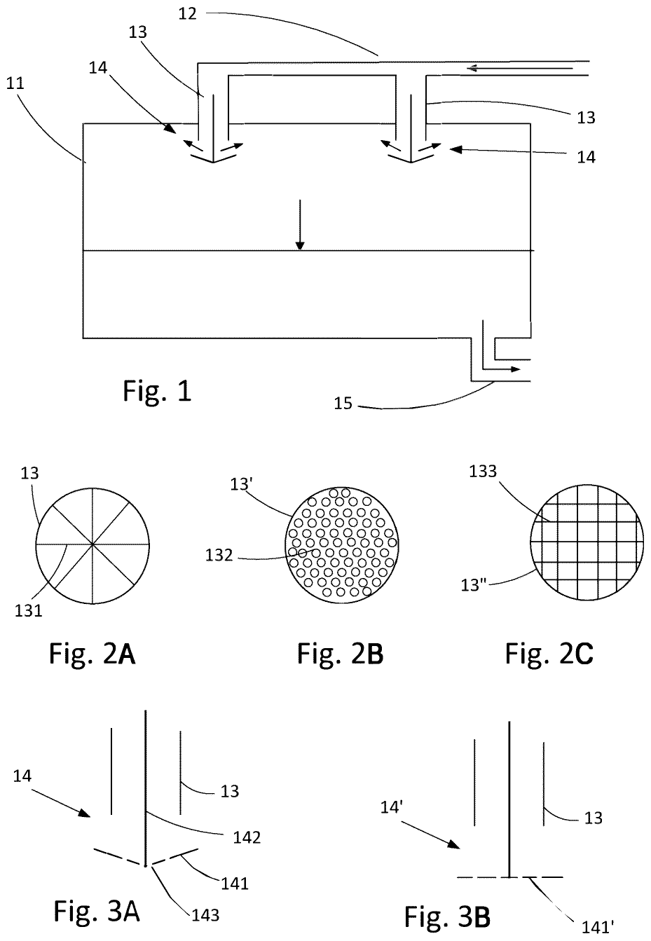

FIG. 1 is a schematic simplified cross-sectional side view of a tank 11 provided with an inert gas interface. A supply pipe 12 for gas leads to the tank 11 and is typically branched to a number of two or more vertical inlet conduits 13, each of which being provided with a primary inlet nozzle 14 of particular design. The inlet nozzles shown in FIG. 1 are both primary inlet nozzles, their design and properties being discussed in further detail below. Typically, the inlet conduit (13) is vertically arranged between the supply pipe (12) and the inlet nozzle (14). Presence of secondary inlet nozzle(s) is optional. FIG. 1 furthermore shows a discharge pipe 15 for volatile liquid, typically oil.

When oil is drained from the tank through discharge pipe 15, inert gas is introduced into the tank through the supply pipe 12, the inlet conduits 13 and the inlet nozzles 14 to avoid underpressure in the tank. It is convenient to establish a certain overpressure in the tank in order to avoid excessive evaporation from the oil surface during drainage. At the same time It is also important to avoid mechanically induced convection between the oil and tank atmosphere, or turbulent mixing over the oil surface, which would both lead to increased evaporation. One element contributing to avoiding turbulence in the tank is the cross-sectional dimension of the inlet conduit 13, which is quite large and typically larger than the cross-section of the supply pipe 12, to thereby allow a slow movement of the inlet gas for all relevant gas rates.

FIGS. 2A-2C are top sectional views of three variants of inlet conduit 13. In the embodiment shown by FIG. 2A, the inlet conduit is divided by partition walls 131 into eight parallel inlet sections, thereby ensuring that the flow of inlet gas is not only slow but also parallel, which means that there is little or no turbulence in the flow. The entire flow of gas reaching the inlet nozzles 14 is thus parallel and laminar and comparatively slow mowing.

FIG. 2B shows a different configuration of the inlet conduit 13′, consisting of a plurality of parallel bores 132 through an otherwise compact tube element. The high number of bores ensures an extreme directional control of the entering gas. The disadvantage compared to the embodiment of FIG. 2A, is that a larger portion of the cross-section is occupied by solid material and that less volume is available for the gas flow.

In the embodiment shown by FIG. 2C, the inlet conduit 13″ is divided by partition walls 133 in a grid pattern. This will provide better directional control than FIG. 2A and occupy less of the cross-section by solid material than the embodiment of FIG. 2B, thus making more volume available for gas flow.

As a whole, all variants shown in FIGS. 2A-2C allow a high directional control of the inlet gas, i.e., a laminar flow of gas reaching the inlet nozzles 14.

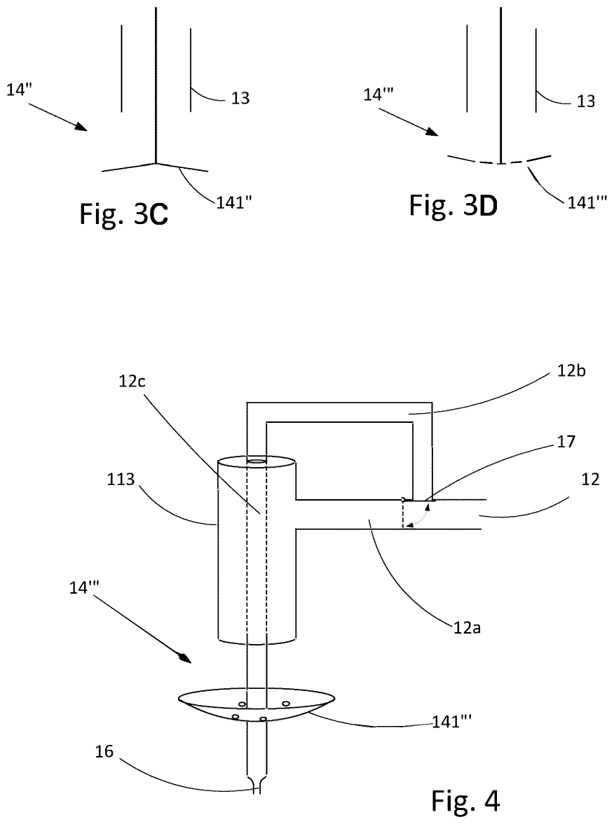

Now we are directing the focus to FIGS. 3A-3D showing four embodiments of the primary inlet nozzle 14 in greater detail. The primary inlet nozzle of FIG. 3A is connected to the lower end of the inlet conduit 13 and comprises a spreader element or spreader disc 141 having an inversely conical shape, i.e., a conical shape with the centre point being the lowermost point of the disc. The inversely conical spreader disc 141 is attached to a rod 142 extending through at least part of the inlet conduit 13. The inversely conical shape of the disc 141 causes the inert gas entering through pipe stub 141 to be forced radially outwards and slightly upwards when leaving the periphery of the disc, i.e., with a vertical velocity component defined as negative herein. The spreader disc 141 of FIG. 3A furthermore shows a number of small holes 143 preventing liquid from being accumulated on the spreader disc. In FIGS. 3A-3D the kind of internal arrangement in the inlet conduit 13 for ensuring an entirely parallel flow, which is illustrated in FIGS. 2A-2C, is omitted.

FIG. 3B also shows a primary inlet nozzle 14′. The only difference of FIG. 3B to as compared to FIG. 3A is the design of the spreader disc 141′ which extends flat and horizontally from its attachment point. This design causes gas entering through inlet conduit 13 to be forced outwards and mainly horizontally, i.e., with no vertical velocity component at the periphery of the spreader disc.

Now turning to FIG. 3C showing a primary inlet nozzle 14″. The only difference of FIG. 3C to as compared to FIGS. 3A and 3B is the design of the spreader disc 141″ which has a moderately conical shape with its centre point being the top point of the spreader disc. This design causes gas entering through inlet conduit 13 to be forced outwards and slightly downwards, i.e., with a limited vertical velocity component at the periphery of the spreader disc.

Now turning to FIG. 3D showing a primary inlet nozzle 14″. The only difference of FIG. 3D to as compared to FIGS. 3A-3C is the design of the spreader disc 141″ which has a curved shape with the concave side facing upwards, its centre point being the lowermost point of the spreader disc. This design causes gas entering through inlet conduit 13 to be forced outwards and slightly upwards, i.e., with a slightly negative vertical velocity component at the periphery of the spreader disc, rather similar to the one of FIG. 3A.

Common for all embodiments 3a-3d is the fact that the horizontal velocity component, for the gas flow leaving the primary inlet nozzle 14, is larger than the vertical velocity component also when regarding absolute values. Additionally, the overall linear velocity is comparatively small due to the fact that the inflowing inert gas is spread over a full circle, i.e., 360 degrees around the spreader discs.

Flat, and in particular inversely conical and curved, spreader discs should preferably be provided with small drainage holes like the holes 143 in FIG. 3A, to prevent liquid from accumulating thereon. These holes should be sufficiently small to not change the general properties of the nozzle (or interface); i.e., the amount of inert gas flowing through such holes should be a lot less than the flow of inert gas over the periphery of the spreader disc. Typically, the flow thorough the holes 143 or the like should constitute less than 10 vol-% of the flow of inert gas and more preferably less than 5 vol-%.

The arrangement described above and shown in FIGS. 1 to 3A-3D ensures a minimum of turbulence around the inlet openings and no turbulence at the surface of the oil, thereby obtaining the desired objective to reduce vaporization to a minimum during unloading of oil.

FIG. 4 shows an embodiment of the inert gas interface that is different from the ones previously shown, mainly in that it exhibits a primary nozzle comprising a spreader disc 141″ like the one of FIG. 3D, arranged below an inlet conduit 113 as well as a secondary inlet nozzle 16. The supply pipe 12 for inert gas is branched to a first pipe stub 12a connected to the inlet conduit 113 and to a second pipe stub 12b connected to the secondary inlet nozzle. The second pipe stub 12b is angled twice in the embodiment shown and exhibits a section 12c, which runs coaxially through the inlet conduit 113 and which is also used as a holder for the spreader disc 141″ before terminated in the secondary inlet nozzle 16.

A change-over valve member 17 is arranged to hold one of the pipe stubs 12a and 12b open at the time, i.e., when one pipe stub 12a or 12b is available for gas supply, the other is not.

When valve member 17 is in its horizontal position as shown in FIG. 4, gas supplied enters the primary nozzle through pipe stub 12a and flows through the broader inlet conduit 113 connected to the primary nozzle and is eventually spread by the spreader disc 141″ in the same manner as explained in relation to FIGS. 1 and 3A-3D.

On the other hand, when valve member 17 is switched to its vertical position, the supply gas enters pipe stub 12b which is connected to the secondary inlet nozzle 16 arranged vertically and without any spreading disc or similar element. The secondary inlet nozzle (16) is designed to supply gas at a comparatively high speed and with a predominant downwards vertical velocity component, the magnitude of which depending upon the pressure applied and the chosen dimensions. Typically, the secondary inlet nozzle (16) is arranged to supply gas with a vertical velocity component exceeding 3 m/s at a level 3 meters below the nozzle.

The secondary inlet nozzle is not intended for use when the tank is unloaded for oil but rather for replacing tank atmosphere in an efficient manner when the tank is already empty and there is no concern for vaporization of volatile fluid. This kind of operation is typically required prior to tank inspection, repair work, etc., and is used to replace the initially explosive tank atmosphere first with an inert gas, and then with breathable air.

As also shown by FIG. 4, an outer face of the secondary inlet nozzle 16 acts as a holder for the spreader disc 242, thereby also fulfilling the task of the rod 142 shown in FIGS. 3A-3D.

Naturally, the change-over valve 17 may be replaced by two separate valves, one in each of the pipe stubs 12a, 12b. The valve or valves may be controlled automatically or remote as well as manually.

Generally speaking, the primary nozzle according to the present invention is arranged to supply gas at a vertical velocity rate less than 0.2 m/s when measured at a level 3 meters below the nozzle.

1-9. (canceled)

10. An oil tank gas inlet assembly connectable to a gas supply pipe (12) for maintenance of pressure and a non-explosive atmosphere during unloading of oil from an oil tank (11), comprising
at least one inlet conduit (13) arranged to direct a unidirectional flow of gas from the supply pipe (12) to a primary inlet nozzle (14) having a spreader element (141, 141′, 141″, 141′″) configured to spread the inflowing inert gas within the tank with a horizontal velocity component larger than a vertical velocity component, wherein
a cross-sectional dimension of the inlet conduit (13) is larger than a cross-sectional dimension of the supply pipe (12).

11. The oil tank gas inlet assembly as claimed in claim 10, wherein the spreader element (141, 141′, 141″, 141′″) is configured to spread the inert gas in a 360 degree circular or conical flow from the primary inlet nozzle (14).

12. The oil tank gas inlet assembly as claimed in claim 11, wherein the spreader element (141, 141′, 141″, 141′″) has a shape of disc selected among the group consisting of flat discs, conical discs, and curved discs.

13. The oil tank gas inlet assembly as claimed in claim 10, wherein the spreader element (141, 141′, 141″, 141′″) has a shape of disc selected among the group consisting of flat discs, conical discs, and curved discs.

14. The oil tank gas inlet assembly as claimed in claim 10, wherein the primary nozzle is arranged to supply gas at a vertical velocity rate less than 0.2 m/s when measured at a level 3 meters below the nozzle.

15. The oil tank gas inlet assembly as claimed in claim 10, wherein the inlet conduit (13) is arranged vertically between the supply pipe (12) and the inlet nozzle (14).

16. The oil tank gas inlet assembly as claimed in claim 11, wherein the inlet conduit (13) is arranged vertically between the supply pipe (12) and the inlet nozzle (14).

17. The oil tank gas inlet assembly as claimed in claim 12, wherein the inlet conduit (13) is arranged vertically between the supply pipe (12) and the inlet nozzle (14).

18. The oil tank gas inlet assembly as claimed in claim 14, wherein the inlet conduit (13) is arranged vertically between the supply pipe (12) and the inlet nozzle (14).

19. The oil tank gas inlet assembly as claimed in claim 10, further comprising a secondary inlet nozzle (16) configured to supply gas with a predominant downwards vertical velocity component.

20. The oil tank gas inlet assembly as claimed in claim 19, wherein the secondary inlet nozzle (16) is configured to supply gas with a vertical velocity component exceeding 3 m/s at a level 3 meters below the nozzle.

21. The oil tank gas inlet assembly as claimed in claim 20, wherein the primary inlet nozzle (14) and the secondary inlet nozzle (16) are connected to a common supply pipe (12) and are charged intermittently in dependence on a position of a change-over valve (17).

22. The oil tank gas inlet assembly as claimed in claim 19, wherein the primary inlet nozzle (14) and the secondary inlet nozzle (16) are connected to a common supply pipe (12) and are charged intermittently in dependence on a position of a change-over valve (17).

23. The oil tank gas inlet assembly as claimed in claim 22, wherein the pipe stub (12c) connected to the secondary inlet nozzle (16) is arranged coaxially within the inlet conduit (113) connected to the primary nozzle (14′″).

24. The oil tank gas inlet assembly as claimed in claim 21, wherein the pipe stub (12c) connected to the secondary inlet nozzle (16) is arranged coaxially within the inlet conduit (113) connected to the primary nozzle (14′″).
